(19) United States
(12) Patent Application Publication
(10) Pub. No.: US 2025/0254117 A1
(43) Pub. Date: Aug. 7, 2025

(54) RESOURCE LEAK DETECTION METHOD AND SYSTEM

(71) Applicant: Airoha Technology (Suzhou) Limited, Suzhou City (CN)

(72) Inventor: Xiyang Zhu, Nanjing City (CN)

(73) Assignee: Airoha Technology (Suzhou) Limited, Suzhou City (CN)

(21) Appl. No.: 19/033,503

(22) Filed: Jan. 22, 2025

(30) Foreign Application Priority Data
Feb. 7, 2024 (CN) 202410175788.3

(51) Int. Cl. H04L 43/55; H04L 43/106

(52) U.S. Cl. CPC H04L 43/55; H04L 43/106

(57) ABSTRACT

A resource leak detection method includes: recording a resource allocation timestamp of a network packet into a tracking list when allocating resources to the network packet; and detecting at least one network packet suspected of resource leak according to a current timestamp and at least one resource allocation timestamp recorded in the tracking list.

### BACKGROUND OF THE INVENTION

### 1. Field of the Invention

The present invention relates to resource leakage detection, and more particularly, to a resource leakage detection method and system for detecting network packets suspected of resource leakage through establishing a tracking list.

### 2. Description of the Prior Art

Generally speaking, when a computer program is running, it usually needs to occupy some resources such as storage resources (e.g., memory resources). After operations of the computer program are ended, the occupied resources need to be released immediately. Resource leakage refers to the situation where a computer program does not release its resources that are no longer in use due to missed release, resulting in the occupied resources being unable to be used again. As resources continue to leak, the available resources in the system will become less and less, leading to system performance degradation. In a worst case, the system may be unable to provide services due to insufficient resources.

Currently, Linux operating systems are widely used in network terminals and network servers, and the network protocol stack module has become an important part of the Linux kernel. Hence, the Linux network protocol stack has also been widely used. Drivers and customized software developed based on the Linux network protocol stack architecture need to use the Linux network packet management application programming interface (API) to implement network packet processing. In the process of driver and custom software development, one common problem is the resource leakage caused by network packets. That is, network packets have resources allocated thereto, and there is a situation where the resources are wasted due to missed releases. This may cause the system to crash due to insufficient resources. This type of problems is not easy to find, and the troubleshooting is often more complicated.

Regarding the resource leakage problem of network packets, the current troubleshooting methods are relatively limited. It is unable to accurately determine which network packets have not released their resources, resulting in low debugging efficiency. If the resource leakage problem of network packets occurs randomly, the debugging efficiency will be further reduced.

### SUMMARY OF THE INVENTION

One of the objectives of the claimed invention is to provide a resource leakage detection method and system for detecting network packets suspected of resource leakage through establishing a tracking list.

According to a first aspect of the present invention, an exemplary resource leak detection method is disclosed. The exemplary resource leak detection method includes: when allocating resources to a network packet, recording a resource allocation timestamp of the network packet into a tracking list; and detecting at least one network packet suspected of resource leak according to a current timestamp and at least one resource allocation timestamp recorded in the tracking list.

According to a second aspect of the present invention, an exemplary resource leak detection system is disclosed. The exemplary resource leak detection system includes a storage device and a processor. The storage device is arranged to store a resource leak detection program code. The processor is arranged to load and execute the resource leak detection program code for performing following operations: when allocating resources to a network packet, recording a resource allocation timestamp of the network packet into a tracking list; and detecting at least one network packet suspected of resource leak according to a current timestamp and at least one resource allocation timestamp recorded in the tracking list.

According to a third aspect of the present invention, an exemplary resource leak detection method is disclosed. The exemplary resource leak detection method includes: recording a resource allocation timestamp of a network packet, wherein the resource allocation timestamp is indicative of a time point at which resources are allocated to the network packet; and in response to a trigger signal, referring to a current timestamp and the resource allocation timestamp to evaluate whether the network packet is a network packet suspected of resource leakage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a resource leakage detection system according to an embodiment of the present invention.

FIG. 2 is a diagram illustrating a network packet forwarding process according to an embodiment of the present invention.

FIG. 3 is a timing diagram of using a tracking list to perform resource leak detection according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

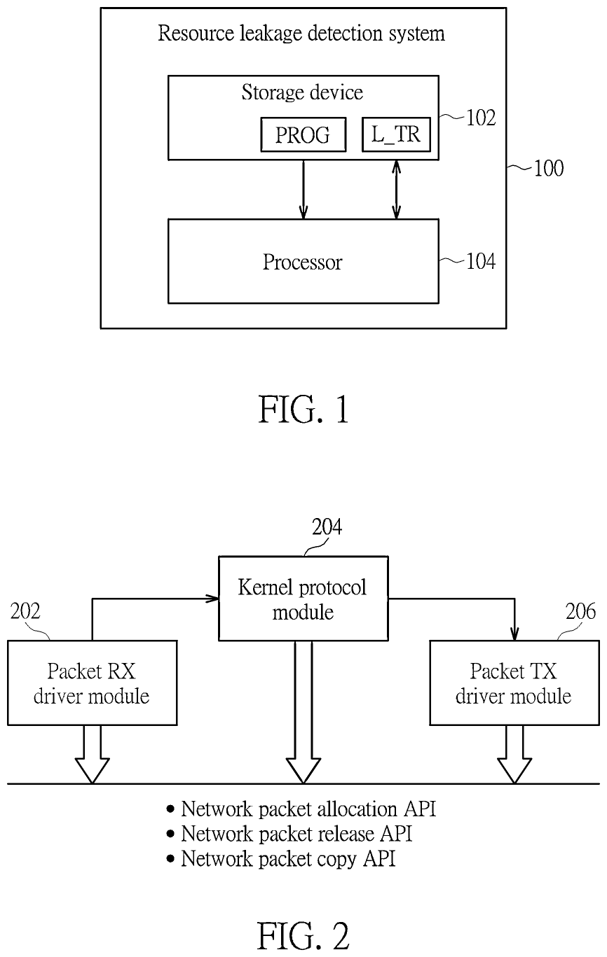

FIG. 1 is a diagram illustrating a resource leakage detection system according to an embodiment of the present invention. The resource leakage detection system 100 may be used to locate the resource leakage problem of Linux network packets. After finding network packets suspected of resource leakage, the resource leakage problem can be reproduced through packet characteristics of the network packets suspected of resource leakage, thereby achieving the objective of speeding up the task of sorting the resource leakage problem out. As shown in FIG. 1, the resource leakage detection system 100 may include a storage device 102 and a processor 104. The storage device 102 is arranged to store the resource leak detection program code PROG. For example, the storage device 102 may be a memory or any component with data storage capability. The processor 104 is coupled to the storage device 102, and is arranged to load and execute the resource leak detection program code PROG. For example, the processor 104 may be a central processing unit (CPU) or any component with instruction execution capability. In this embodiment, the processor 104 executes the resource leak detection program code PROG for performing at least the following operations: when allocating resources to a network packet, recording a resource allocation timestamp of the network packet into a tracking list L_TR; and detect at least one network packet suspected of resource leakage according to a current timestamp (i.e., current time) and at least one resource allocation timestamp currently recorded in the tracking list L_TR (which indicates a start time of a life cycle of a corresponding network packet, i.e., a time point at which the resources are allocated to the corresponding network packet as indicated by the resource allocation timestamp). In addition, when the resources occupied by the network packet are released (for example, the resources are released after forwarding of the network packet is completed), the processor 104 executes the resource leakage detection program code PROG to delete the resource allocation timestamp of the network packet from the tracking list L_TR. That is, the tracking list L_TR no longer needs to continue tracking the life cycle of this network packet.

Generally speaking, network packets are received from hardware (e.g., a network interface card (NIC)), processed by software, and finally sent out through hardware. Therefore, each network packet has a limited life cycle. FIG. 2 is a diagram illustrating a network packet forwarding process according to an embodiment of the present invention. Regarding a network packet, its life cycle is roughly as follows. First, a packet receive (RX) driver module 202 included in the driver (i.e., software driver) is responsible for creating and allocating resources to the network packet, which involves a network packet allocation API. The intermediate processing flow will perform certain processing (e.g., processing of the Linux network protocol stack) through a software module (e.g., a kernel protocol module 204 in the Linux kernel), and may also perform operations such as a copy operation and a release operation, which involves the network packet copy API and the network packet release API. Finally, when the network packet is successfully sent out via a packet transmit (TX) driver module 206 included in the driver (i.e., software driver), the resources occupied by the network packet will be released, which involves a network packet release API.

Since each network packet has a limited life cycle, the present invention proposes a method for tracking life cycles of network packets to find network packets suspected of resource leakage, such as establishing a tracking list L_TR to record start time of life cycles of network packets. When the network packet does not release the occupied resources after an end of its expected life cycle, the network packet can be regarded as a network packet suspected of resource leakage.

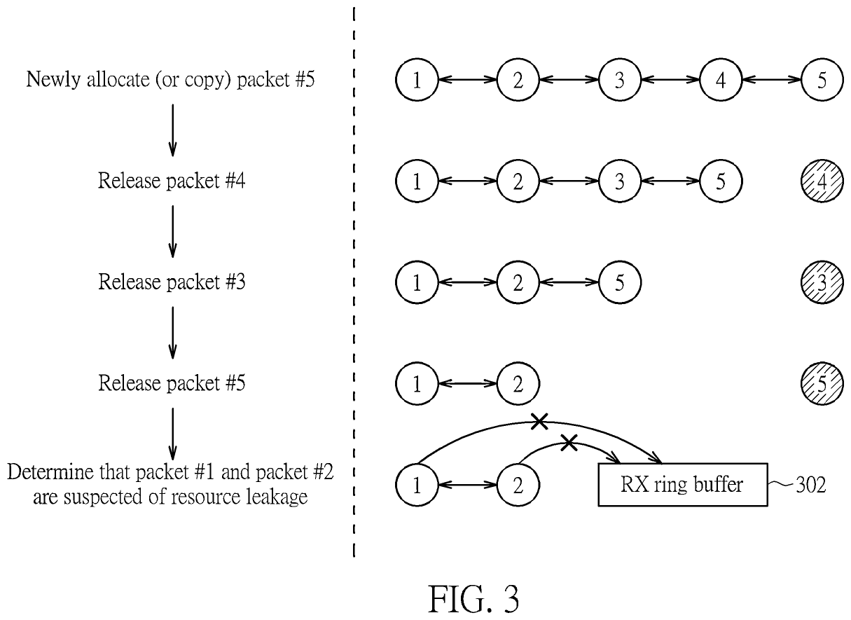

FIG. 3 is a timing diagram of using the tracking list L_TR to perform resource leak detection according to an embodiment of the present invention. The tracking list L_TR records related information (which includes identification information, memory addresses, resource allocation timestamps, etc.) of network packets to which resources (e.g., memory resources) have been allocated. Suppose that the tracking list L_TR has recorded the related information (which includes resource allocation timestamps) of four packets (which include packet #1, packet #2, packet #3 and packet #4). When resources are allocated to a latest received packet #5 (or when resources are allocated to packet #5 generated by copying an existing packet), the related information (which includes a resource allocation timestamp) of packet #5 is added to the tracking list L_TR. In this embodiment, the resources occupied by packet #4, packet #3, and packet #5 are released in sequence. As shown in FIG. 3, when the resources occupied by packet #4 are released, the related information (which includes a resource allocation timestamp) of packet #4 is deleted from the tracking list L_TR. At this moment, the tracking list L_TR only records related information (which includes resource allocation timestamps) of packet #1, packet #2, packet #3 and packet #5. Then, when the resources occupied by packet #3 are released, the related information (which includes a resource allocation timestamp) of packet #3 is deleted from the tracking list L_TR. At this moment, the tracking list L_TR only records related information (which includes resource allocation timestamps) of packet #1, packet #2, and packet #5. Finally, when the resources occupied by packet #5 are released, the related information (which includes a resource allocation timestamp) of packet #5 is deleted from the tracking list L_TR. At this moment, the tracking list L_TR only records related information (which includes resource allocation timestamps) of packet #1 and packet #2.

Suppose that the processor 104 checks some judgment rules (for example, whether the available capacity of the memory is too low) and determines that the system suffers a resource leakage problem. The processor 104 executes the resource leakage detection code PROG, for detecting network packet(s) suspected of resource leakage according to the current timestamp (i.e., the current time) and at least one resource allocation timestamp currently recorded in the tracking list L_TR (i.e., the start time of the life cycle of at least one network packet). That is, in response to a trigger signal indicating that a resource leakage problem occurs, the processor 104 refers to the current timestamp and the resource allocation timestamp to detect whether the network packet is a network packet suspected of resource leakage. For example, the processor 104 executes the resource leak detection program code PROG to compare the current timestamp with the resource allocation timestamp of packet #1, to determine whether a difference between the current timestamp and the resource allocation timestamp of packet #1 exceeds a predetermined value (which may be larger than or equal to an expected value of a life cycle of a network packet). When the difference exceeds the predetermined value, it means that packet #1 is very likely to be a network packet with resource leakage. Similarly, the processor 104 executes the resource leak detection program code PROG to compare the current timestamp with the resource allocation timestamp of packet #2, to determine whether a difference between the current timestamp and the resource allocation timestamp of packet #2 exceeds the predetermined value. When the difference exceeds the predetermined value, it means that packet #2 is very likely to be a network packet with resource leakage.

The packet RX driver module 202 reads network packets received by the network interface card through a receive (RX) ring buffer 302. For example, the RX ring buffer 302 has a circular data structure for storing a plurality of packet descriptors, where the plurality of packet descriptors point to a plurality of network packets, respectively. Due to inherent characteristics of the RX ring buffer 302, the network packets indicated by the RX ring buffer 302 (i.e., network packets corresponding to the packet descriptors recorded in the RX ring buffer 302) may remain unreleased for a long period of time. If such data is excluded from network packets suspected of resource leakage, the resource leakage detection efficiency can be further improved.

In some embodiments of the present invention, when the difference between the resource allocation timestamp of packet #1 and the current timestamp exceeds the predetermined value, the processor 104 further executes the resource leak detection program code PROG to determine whether packet #1 belongs to a network packet indicated by the RX ring buffer 302 that is accessed by the driver. If packet #1 does not belong to a network packet indicated by the RX ring buffer 302, the processor 104 determines that packet #1 is a network packet suspected of resource leakage. Otherwise, the processor 104 does not treat packet #1 as a network packet suspected of resource leakage. Similarly, when the difference between the resource allocation timestamp of packet #2 and the current timestamp exceeds the predetermined value, the processor 104 executes the resource leak detection program code PROG to determine whether packet #2 belongs to a network packet indicated by the RX ting buffer 302 that is accessed by the driver. If packet #2 does not belong to a network packet indicated by the RX ring buffer 302, the processor 104 determines that packet #2 is a network packet suspected of resource leakage. Otherwise, the processor 104 does not treat packet #2 as a network packet suspected of resource leakage. However, this is for illustrative purposes only, and is not meant be a limitation of the present invention. That is, any designs using the tracking list L_TR proposed by the present invention to detect network packets suspected of resource leakage falls within the scope of the present invention.

The cause of the resource leakage problem is often related to network packets with specific packet characteristics. If the packet characteristics of the network packets that trigger the resource leakage are known, the resource leakage problem can be reproduced to speed up the task of sorting the resource leakage problem out. Therefore, after detecting the network packets suspected of resource leakage with the aid of the tracking list L_TR, the processor 104 can reproduce the resource leakage problem to speed up the task of sorting the resource leakage problem out. For example, the processor 104 executes the resource leak detection program PROG to read the message content of the network packet suspected of resource leakage, and then simulates the packet forwarding of the network packet suspected of resource leakage to reproduce the resource leakage problem, thereby speeding up the task of sorting the resource leakage problem out. In other words, since resource leakage problems can be reproduced repeatedly and no longer occur randomly, debugging efficiency can be improved greatly. For example, with the aid of packet characteristics of network packets suspected of resource leakage, debugging information and inspection code can be inserted to suspicious points in the program code. This can speed up the task of sorting resource leak issues out.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A resource leak detection method comprising:
when allocating resources to a network packet, recording a resource allocation timestamp of the network packet into a tracking list; and
detecting at least one network packet suspected of resource leak according to a current timestamp and at least one resource allocation timestamp recorded in the tracking list.

2. The resource leak detection method of claim 1, further comprising:
when the resources occupied by the network packet are released, deleting the resource allocation timestamp of the network packet from the tracking list.

3. The resource leak detection method of claim 1, wherein detecting the at least one network packet suspected of resource leak according to the current timestamp and the at least one resource allocation timestamp recorded in the tracking list comprises:
comparing a difference between the current timestamp and a resource allocation timestamp recorded in the tracking list with a predetermined value; and
in response to the difference being larger than the predetermined value, determining that a network packet corresponding to the resource allocation timestamp is a network packet suspected of resource leakage.

4. The resource leak detection method of claim 3, wherein determining that the network packet corresponding to the resource allocation timestamp is the network packet suspected of resource leakage comprises:
checking whether the network packet corresponding to the resource allocation timestamp belongs to a network packet indicated by a receive (RX) ring buffer that is accessed by a driver; and
in response to the network packet corresponding to the resource allocation timestamp not belonging to the network packet indicated by the RX ring buffer, determining that the network packet corresponding to the resource allocation timestamp is the network packet suspected of resource leakage.

5. The resource leak detection method of claim 1, further comprising:
after detecting a network packet suspected of resource leakage, simulating packet forwarding of the network packet suspected of resource leakage to reproduce a resource leakage problem.

6. A resource leak detection system comprising:
a storage device, arranged to store a resource leak detection program code; and
a processor, arranged to load and execute the resource leak detection program code for performing following operations:
when allocating resources to a network packet, recording a resource allocation timestamp of the network packet into a tracking list; and
detecting at least one network packet suspected of resource leak according to a current timestamp and at least one resource allocation timestamp recorded in the tracking list.

7. The resource leak detection system of claim 6, wherein the processor is further arranged to execute the resource leak detection program code for performing following operations:
when the resources occupied by the network packet are released, deleting the resource allocation timestamp of the network packet from the tracking list.

8. The resource leak detection system of claim 6, wherein detecting the at least one network packet suspected of resource leak according to the current timestamp and the at least one resource allocation timestamp recorded in the tracking list comprises:
comparing a difference between the current timestamp and a resource allocation timestamp recorded in the tracking list with a predetermined value; and
in response to the difference being larger than the predetermined value, determining that a network packet corresponding to the resource allocation timestamp is a network packet suspected of resource leakage.

9. The resource leak detection system of claim 8, wherein determining that the network packet corresponding to the resource allocation timestamp is the network packet suspected of resource leakage comprises:
checking whether the network packet corresponding to the resource allocation timestamp belongs to a network packet indicated by a receive (RX) ring buffer that is accessed by a driver; and
in response to the network packet corresponding to the resource allocation timestamp not belonging to the network packet indicated by the RX ring buffer, determining that the network packet corresponding to the resource allocation timestamp is the network packet suspected of resource leakage.

10. The resource leak detection system of claim 6, wherein the processor is further arranged to execute the resource leak detection program code for performing following operations:
after detecting a network packet suspected of resource leakage, simulating packet forwarding of the network packet suspected of resource leakage to reproduce a resource leakage problem.

11. A resource leak detection method comprising:
recording a resource allocation timestamp of a network packet, wherein the resource allocation timestamp is indicative of a time point at which resources are allocated to the network packet; and
in response to a trigger signal, referring to a current timestamp and the resource allocation timestamp to evaluate whether the network packet is a network packet suspected of resource leakage.

12. The resource leak detection method of claim 11, wherein the trigger signal is indicative of a resource leakage problem.

13. The resource leak detection method of claim 11, wherein in response to the trigger signal, referring to the current timestamp and the resource allocation timestamp to evaluate whether the network packet is the network packet suspected of resource leakage comprises:
in response to the network packet belonging to a network packet indicated by a receive (RX) ring buffer that is accessed by a driver, determining that the network packet is not the network packet suspected of resource leakage.
